(19) United States
(12) Patent Application Publication
(10) Pub. No.: US 2013/0112663 A1
(43) Pub. Date: May 9, 2013

(54) Method For Arc-Welding Aluminum-Coated Metal Parts Using Oxidizing Gas

(71) Applicants: Pascal Bertin, Houston, TX (US); Olivier Dubet, Houston, TX (US); Sebastien Gadrey, Houston, TX (US); Frederic Richard, Houston, TX (US)

(72) Inventors: Pascal Bertin, Houston, TX (US); Olivier Dubet, Houston, TX (US); Sebastien Gadrey, Houston, TX (US); Frederic Richard, Houston, TX (US)

(21) Appl. No.: 13/809,531

(22) PCT Filed: May 5, 2011
(86) PCT No.: PCT/FR11/51013

§ 371 Date: Jan. 10, 2013

(30) Foreign Application Priority Data
Jul. 13, 2010 (FR) 1055689

(51) Int. Cl. B23K 35/38; B23K 9/173; B23K 9/16

(52) U.S. Cl. CPC B23K 35/38; B23K 9/16; B23K 9/173
USPC 219/74

(57) ABSTRACT

The invention relates to an electric arc welding method for welding at least one metal part including an aluminum based surface coating, using a shielding gas. According to the invention, the metal of the aforementioned metal part is melted by the electric arc alone without the use of any laser beam. The invention is characterized in that the shielding gas comprises a mixture of argon and/or helium, nitrogen, and an oxidizing compound selected from oxygen and carbon dioxide.

The invention relates to a process for the electric-arc welding of steel parts comprising a surface coating based on aluminum, in particular a coating of aluminum and silicon, using a shielding gas formed from nitrogen and argon and/or helium and also containing less than 10% by volume of CO₂ or O₂.

Certain steels coated with aluminum or with an alloy based on aluminum, such as USIBOR™ steels, have very high mechanical characteristics after hot-drawing and are, therefore, increasingly used in the field of the construction of motor vehicles, when a weight saving is desired. Indeed, these steels are designed to be thermally treated then quenched during the hot-drawing operation and the mechanical characteristics which result therefrom enable a very significant lightening of the weight of the vehicle compared to a standard high yield strength steel. They are mainly used for manufacturing bumper beams, door reinforcements, center pillars, window pillars, etc.

Other steels coated with aluminum or an aluminum alloy are also used for their properties of resistance to corrosion and to heat. Mention may especially be made of the Aluzinc® steels used for external constructions or switch boxes, Alusi® and Alupur® steels for mufflers, heat screens, lagging of boilers, flue linings, applications in electric power plants or in the petrochemical industry.

In theory, all conventional arc welding processes, such as MIG welding, MAG welding or else brazing processes, can be used for assembling these aluminized steels.

However, it has been observed in practice that after an operation for the arc-welding of parts coated with aluminum or with an aluminum alloy, a phase with lower tensile strength appeared at the weld metal zone of the welded joint. This phase consists of intermetallic compounds or of delta ferrite.

In case of Usibor, after analysis, it was determined that this phase contains a significant percentage of aluminum which gives rise to no austenitic transformation of the steel during the treatment thereof before drawing, that is to say that this phase remains in the form of delta ferrite and the result thereof is a lower hardness than the rest of the part having undergone a martensitic/bainitic transformation.

However, the non-transformed phase may lead to cracks or even a rupture of the joint. Indeed, these zones containing the delta ferrite phase, having incorporated aluminum, have a lower resistance of the weld than that of the base metal.

A process for laser-arc hybrid welding of steel parts with a surface coating based on aluminum has already been proposed by document EP-A-1878531.

Although this process gives good results in certain cases, the implementation thereof is complicated since it requires combining the effects of an electric arc with those of a laser beam.

Furthermore, it makes it necessary to invest both in an arc welding source and above all in a laser welding source, which generates a high cost and additional maintenance operations which may be detrimental to the overall productivity of the process.

The applications targeted in MIG welding are the welding of studs, or various components made of steel to aluminized sheets, or the welding of two sheets together as in the case of mufflers.

The problem which is faced is hence to propose a welding process of simple implementation that makes it possible to obtain good mechanical properties of the welded joint, in particular tensile properties, during an operation for welding steel parts coated with aluminum or with an aluminum alloy, and also to obtain a stable transfer of the filler metal.

The solution of the invention is a process for the electric-arc welding of at least one steel part comprising a surface coating based on aluminum, using a shielding gas, wherein the melting of the metal of said metallic part is carried out solely by the electric arc, with the exclusion of the presence of any laser beam participating in the melting of the metal, characterized in that the shielding gas consists of a mixture of argon and/or helium, nitrogen (N₂) and an oxidizing compound chosen from oxygen (O₂) and carbon dioxide (CO₂).

The gas mixture is therefore at least ternary since it is formed from argon, helium or both to which not only nitrogen is added but also O₂ or CO₂ so as to constitute an Ar/N₂/CO₂, Ar/N₂/O₂, He/N₂/O₂ or He/N₂/CO₂ ternary gas mixture or an Ar/He/N₂/O₂ or Ar/He/N₂/CO₂ quaternary mixture.

As already stipulated, the expression “process for the electric-arc welding” is understood to mean a welding process within the context of which the melting of the metal is carried out solely by an electric arc, which therefore excludes the presence of any laser beam brought into play in order to melt the metal of the part or parts to be welded. It then follows therefrom that arc/laser hybrid welding processes are excluded from the field of the present invention, an arc alone not reacting in the same way as an arc assisted by a laser beam.

Depending on the case, the process of the invention may comprise one or more of the following characteristics:

the shielding gas contains at least 0.025% and at most 30% by volume of nitrogen.

the shielding gas contains at least 0.025% and at most 20% by volume of nitrogen.

the shielding gas contains at least 0.025% and at most 15% by volume of nitrogen.

the shielding gas contains at least 3% by volume of nitrogen.

the shielding gas contains at least 4% by volume of nitrogen.

the shielding gas contains at least 10% by volume of nitrogen.

the shielding gas contains at most 9% by volume of nitrogen.

the shielding gas contains at most 8% by volume of nitrogen.

the shielding gas contains at most 10% by volume of oxygen or of CO₂.

the shielding gas contains at most 8% by volume of oxygen or of CO₂.

the shielding gas contains at least 1% by volume of oxygen or of CO₂.

the shielding gas contains at least 5% by volume of nitrogen and/or at most 7% by volume of nitrogen, preferably around 6% of nitrogen.

the shielding gas contains at least 5.5% by volume of nitrogen and at most 6.5% by volume of nitrogen.

the steel part or parts comprise an aluminum-based surface coating having a thickness between 5 and 100 μm, preferably of less than or equal to 50 μm.

the metal part or parts are made of steel with a surface coating based on aluminum and silicon.

the metal part or parts comprise a surface coating based on aluminum and silicon containing a proportion of aluminum between 5 and 100 times greater than that of silicon, for example a proportion of aluminum of 90% by weight and a proportion of silicon of 10% by weight, i.e. a surface coating layer comprising 9 times more aluminum than silicon. The coating covers at least one surface of the part or parts but no or virtually no aluminum-based coating is present on the edges of ends of said part or parts, that is to say on the edges of a sheet for example.

the metal part or parts comprise a surface coating based on aluminum and silicon containing a proportion of aluminum between 5 and 50 times greater than that of silicon, in particular a proportion of aluminum between 5 and 30 times greater than that of silicon, in particular a proportion of aluminum between 5 and 20 times greater than that of silicon.

it is a MIG welding process with consumable filler wire, for example a solid wire or a flux-cored wire.

the part or parts to be welded are one or some motor vehicle components.

the welding voltage is between 14 and 35 V.

the welding intensity is between 80 and 300 A.

the part or parts to be welded have a thickness between 0.6 and 2.5 mm, preferably between 1 and 2 mm. The thickness is considered at the joint plane to be produced, that is to say at the location where the metal is melted by the electric arc in order to form the welding joint, for example at the end edge of the part or parts to be welded.

the pressure of the gas is between 2 and 15 bar, preferably less than 12 bar, in particular around 4 to 8 bar.

the flow rate of the gas is less than 30 l/min, in general less than 25 /min, typically between around 15 and 20 l/min depending on the application considered.

several parts are welded with one another, typically two parts, it being possible for said parts to be identical or different, in particular in terms of shapes, thicknesses, etc.

the parts are made of highly alloyed steel (>5% by weight of alloy elements), weakly alloyed steel (<5% by weight of alloy elements) or unalloyed steel, for example carbon steel.

the welding wire is a solid wire or a flux-cored wire.

the welding wire has a diameter between 0.5 and 5 mm, typically between around 0.8 and 2.5 mm.

The invention will now be better understood owing to the following description.

The proposed solution is therefore to produce a welding of aluminized parts, that is to say of parts comprising a surface coating of aluminum or of an aluminum alloy, such as an Al/Si alloy, by means of an electric arc and of a particular shielding gas.

According to the present invention, use is made, during the welding, of a shielding gas that makes it possible to obtain a stabilization of the arc on the aluminum and to decrease the dissolution of the aluminum-based coating in the metallic part or parts to be welded.

This particular shielding gas is composed of argon and/or helium with an addition, by volume, of nitrogen of 0.025% to 30%, preferably from 3% to 10% of nitrogen, and of 2% of oxygen or CO₂.

This gas mixture results, by reaction between the aluminum and the nitrogen, in the formation of aluminum nitrides which have a better electrical emissivity, thus reducing the arc movements and the size of the cathode spot, therefore leading to a stabilization of the welding arc.

Furthermore, the aluminum nitrides float at the surface of the pool, thus preventing the dissolution of the aluminum present at the surface of the part. This results in a suppression or at least a significant reduction in the incorporation of aluminum into the weld, therefore an improvement of the tensile strength due to a total or almost total disappearance of the phase in the form of delta ferrite or of intermetallic compounds that is customarily observed.

Moreover, the presence of an oxidizing compound, namely O₂ or CO₂, in a small proportion makes it possible to increase the stabilization of the arc and to improve the melting of the filler metal.

The gas mixture used can be produced either directly on site by mixing of the constituents of the desired mixture in the desired proportions using a gas mixer, or be in pre-packaged form, that is to say produced in a packaging factory then transported to its place of use in suitable gas containers, such as welding gas cylinders.

### EXAMPLES

The process of the invention has given good results during an operation for the manual MIG arc welding of Usibor 1500™ parts, that is to say of steel parts coated with a 30 μm layer of an aluminum/silicon (Al/Si) alloy in respective proportions of 90% and 10% by weight.

The welded parts have a thickness of 1.2 mm.

Within the context of the tests carried out, the gas used (% by volume) which is dispensed at a flow rate of 20 l/min and at a pressure of 4 bar, is:

Test A (comparative): pure argon.

Test B (comparative): mixture formed of argon and of 2% by volume of nitrogen (N₂).

Test C (comparative): mixture formed of argon and of 4% N₂.

Test D (comparative): mixture formed of argon and of 6% N₂.

Test E (comparative): mixture formed of argon and of 8% N₂.

Test F (comparative): mixture formed of argon and of 8% CO₂.

Test G (invention): mixture formed of argon, of 6% N2 and of 8% CO₂.

Test H (invention): mixture formed of argon, of 6% N₂ and of 1% CO₂.

The torch used is a Dinsee reference MIG torch fed by a filler wire of Nertalic 88 (ER 100 SG: AWS, A 5.28) type having a diameter of 1.2 mm, which is delivered at a rate of 2.8 to 3.5 m/min.

The welding voltage is around 15 V and the intensity is around 128 A which are obtained by virtue of a generator of Digi@wave 400 type (short arc/short arc +) in synergic mode (EN 131) sold by Air Liquide Welding France.

The welding speed achieved is 20 cm/min.

The parts to be welded together form an angle of around 45° and the joint plane formed by the apex of the angle

The results obtained show that the presence of N₂ in the argon leads to much better results than the use of argon alone.

Indeed, with argon alone (Test A), the arc is unstable and the transfer erratic (large drops). The joints made under argon all have a degraded appearance. It is possible in particular to observe a lack of wetting at the edge of the beads and these have a significant overthickness. Furthermore, during the welding, the formation of large spatters of molten metal droplets and also a lot of fumes is observed.

Conversely, with the Ar/N₂ mixtures, there is a notable improvement in the results, which increases proportionally to the N₂ content in the mixture.

Thus, with the Ar/N₂ mixture containing 2% N₂ (Test B), the transfer of metal is more stable than in Test A but the bead is not completely free of any defect. Indeed, the arc stability may still be occasionally disturbed, although arc ruptures are not present very much, or are even nonexistent. The phenomenon of formation of large drops during the welding also decreases. The addition of 2% nitrogen to the argon in fact improves above all the top/bottom wetting of the bead.

By increasing the addition of nitrogen to 4% in the argon (Test C), without changing the other parameters, in particular the electrical parameters, a general improvement in the surface appearance and an acceptable wetting at the top/bottom edge of the bead are observed, and also an improvement of the surface appearance of the bead: weak solidification lines and not very large overthickness at the center. These results are satisfactory and reproducible. The melting of the wire is good with a correct and more stable transfer. The corner joint results have an acceptable wetting at the top/bottom edge of the bead. The pool remains on the other hand still slightly “cold” and may be difficult to handle under certain conditions.

The increase of the addition of nitrogen to 6% (Test D) results in a general and more notable improvement of the surface appearance and a good wetting at the top/bottom edge of the bead. The surface of the bead has only very faint lines and also a very small central overthickness.

In Test E, 8% nitrogen is added to the argon. The surface roughness of the bead has decreased further, the wetting is good and there is little adherent spatter. From an operational point of view, the addition of 8% nitrogen to the argon makes it possible to obtain a stable transfer with good melting of the wire. It is interesting to note that with this mixture a real operational “flexibility” is obtained because it enables an adjustment of parameters (variation of wire speed or variation of voltage) which is not possible under pure argon and not necessarily as easy with the other argon/nitrogen mixtures tested.

In Test F, the addition of 8% CO₂ to argon alone generates an arc stability necessary for producing the joint but the appearance of the bead is degraded and areas of delta ferrite remain that are damaging to the mechanical properties of the joint.

The addition of CO₂ alone to argon does not therefore make it possible to solve the problem linked to the formation of delta ferrite, but on the other hand makes it possible to stabilize the arc and to improve the weldability.
On the other hand, Test G shows that the addition of 8% CO₂ to a mixture of argon to which 6% nitrogen is added makes it possible to eliminate the delta ferrite areas and give an improved arc stability compared to Test E. On the other hand the bead appearance is degraded.

Test H shows that the addition of 1% CO₂ to a mixture of argon to which 6% nitrogen is added makes it possible to eliminate the delta ferrite areas, to improve the arc stability compared to Test E and makes it possible to obtain a good bead appearance.

The addition of CO₂ to an Ar/N₂ mixture therefore makes it possible to solve the problem linked to the formation of delta ferrite while resulting in a good arc stability.

These results clearly show that an addition of nitrogen and of an oxidizing compound in small proportions, in particular CO₂ or O₂, to argon makes it possible to greatly improve the quality of the welding of steels coated with a surface layer of aluminum/silicon alloy.

The improvement is even more notable when the nitrogen content increases, which would encourage at least 8% nitrogen in argon to be used.

However, radiographic tests carried out in parallel have shown that this nitrogen content must not be excessive when it is also desired to avoid the formation of porosities in the deposited metal.

Indeed, the radiographic tests carried out on the beads obtained in Tests B to E show that for nitrogen contents ranging up to around 6%, the level of porosities is acceptable, that is to say in accordance with the recommendations of certain standards, such as the standards NF-EN 287-1, NF EN ISO 5817 and EN 462-1 W10.

On the other hand, starting from an addition of 8% nitrogen to the argon (Test E), porosities are sometimes encountered at the beginning of the weld beads. These porosities mean that the joints produced with this percentage may not be in accordance with the standard.

It is therefore preferable to limit the nitrogen content to 6% or to provide appendages at the start and end of the bead, where the porosities were encountered.

In addition, micrographic tests were also carried out so as to visualize the structure of the beads after welding.

These tests revealed, for the beads obtained within the context of Test A, a ductile phase in the form of white areas due to the dissolution of aluminum and of silicon originating from the Al/Si layer covering the parts. These areas contain delta ferrite which is damaging to the mechanical properties of the welded joints.

Conversely, after examination of the beads obtained within the context of Tests B to E, it appears that the delta ferrite areas are significantly reduced by the addition of nitrogen to the shielding gas. Starting from 4% nitrogen, the delta ferrite areas no longer appear in the weld metal zone.

This demonstrates the advantage of the addition of nitrogen to argon when it is desired to avoid the formation of delta ferrite areas in the weld beads produced on steel parts coated with an Al/Si layer, such as the steels of Usibor type. It should be noted that additional tests have shown that all or some of the argon could be replaced by helium, without loss of the benefits resulting from the addition of nitrogen.

Hence, use is made of a proportion of nitrogen of less than 10% by volume, preferably between 4 and 8% by volume, advantageously between around 5% and 7% by volume, and more particularly of the order of 6% by volume, the remainder being argon and/or helium.

Moreover, regarding the presence of oxygen or CO₂, it can be said that the influence of these compounds is significant as regards the improvement of the arc stability and of the weldability.

1-11. (canceled)

12. A process for the electric-arc welding of at least one metallic part comprising a surface coating based on aluminum, using a shielding gas, wherein the melting of the metal of said metallic part is carried out solely by the electric arc, with no laser beam contributing to the melting, wherein the shielding gas consists of a mixture of argon and/or helium, nitrogen and an oxidizing compound chosen from oxygen (O2) and carbon dioxide (CO2), said shielding gas containing at least 0.025% and at most 30% by volume of nitrogen.

13. The process of claim 12, wherein the shielding gas contains at most 10% by volume of oxygen or CO2.

14. The process of claim 12, wherein the shielding gas contains at least 3% by volume of nitrogen or less than 10% by volume of nitrogen.

15. The process of claim 12, wherein the shielding gas contains at least 4% by volume of nitrogen and at most 8% by volume of nitrogen.

16. The process of claim 12, wherein the shielding gas contains from 5% to 7% by volume of nitrogen.

17. The process of claim 12, wherein the metallic part or parts comprise a surface coating based on aluminum having a thickness between 5 and 100 μm.

18. The process of claim 12, wherein the metal part or parts are made of steel with a surface coating based on aluminum and silicon.

19. The process of claim 12, wherein the metal part or parts comprise a surface coating based on aluminum and silicon containing a proportion of aluminum between 5 and 100 times greater than that of silicon.

20. The process of claim 12, wherein it is a MIG welding process with consumable filler wire.

21. The process of claim 12, wherein the part or parts to be welded are one or some motor vehicle components.

22. The process of claim 12, wherein several parts are welded with one another.
